(19) United States
(12) Patent Application Publication
(10) Pub. No.: US 2022/0341748 A1
(43) Pub. Date: Oct. 27, 2022

(54) Method for Providing Map Data for at Least Two Types of Zones

(71) Applicant: Bayerische Motoren Werke Aktiengesellschaft, Muenchen (DE)

(72) Inventors: Johannes DIRNECKER, Muenchen (DE); Irmengard DITZELL, Freising (DE); Marcel EWERS, Dachau (DE); Harald HOFMEIER, Eching (DE); Achim SONNTAG, Olching (DE)

(21) Appl. No.: 17/765,945

(22) PCT Filed: Sep. 3, 2020
(86) PCT No.: PCT/EP2020/074646

§ 371 Date: Apr. 1, 2022

(30) Foreign Application Priority Data
Nov. 28, 2019 (DE) 10 2019 132 374.6

(51) Int. Cl. G01C 21/00; G01C 21/32; G01C 21/34

(52) U.S. Cl. CPC G01C 21/3807; G01C 21/3878; G01C 21/32; G01C 21/3461

(57) ABSTRACT

A method for providing map data for at least two types of zones includes providing first map data for two types of zones, wherein the zones are described by regions; providing second map data for one of the types of zones, wherein the type is described by the listing of road sections; providing a map which contains all of the road sections and the positions thereof; verifying, by way of the map, whether the regions indicated in the first map data for the one of the types of zones correspond with the road sections indicated in the second map data for the one of the types of zones; in the event that they do not correspond, modifying the zones of the one of the types of zones in the first map data; and providing the first map data, corrected as applicable.

### BACKGROUND AND SUMMARY OF THE INVENTION

The invention relates to a method for providing map data for at least two types of zones, and to a vehicle that comprises map data produced using this method.

Navigation systems for vehicles are nowadays well-known. Settings by way of which the route is able to be set according to the driver's wishes, for example avoiding toll roads or motorway tax roads, are also known. It is also known to avoid entire areas, called avoidance areas, which have until now been observed mainly for safety reasons. It is expected that, in the future, zones will also be defined in which only reduced vehicle emissions from internal combustion engines, low emission zones (LEZ), and even no vehicle emissions from internal combustion engines, zero emission zones (ZEZ), will be permitted.

The zones may be provided in a further so-called layer to form a map, wherein the map comprises the road sections, also called links. The zones may be described in two different ways: as a region that is able to be defined using GPS coordinates, or as a list of road sections that is able to be defined through the identification of what are known as link IDs. The region may be defined in terms of position and extent or shape, or else defined as a list of the position of smaller regions that always have the same shape. The region typically comprises multiple road sections. In the list of road sections, a zone is defined that stipulates which road sections appear in the list.

Each provision technique has advantages and disadvantages: the region-based display often exhibits low accuracy. On the other hand, the display is able to be achieved using small amounts of data with at the same time low maintenance effort. The road section-based display allows high accuracy, but requires large amounts of data and more maintenance effort.

The problem for a person skilled in the art is to provide an improved region-based display. The problem is in particular that of ascertaining accurate and up-to-date information for PHEVs and BEVs by comparing the region-based database (contains information about the circumstances under which entry into the zone is permitted) with the standard map (contains only the information about a ban on access or roads with limited driveability).

The problem is solved by the claimed invention.

The invention relates to a method for providing map data for at least two types of zones, LEZ and ZEZ, comprising: providing first map data for the two types of zones, LEZ and ZEZ, wherein the zones are described by regions; providing two items of map data for one of the types of zones, ZEZ, wherein the one type is described by the list of road sections; providing a map that contains all of the road sections and their position; checking, by way of the map, whether the regions mentioned in the first map data for ZEZ match the road sections mentioned in the second map data for ZEZ, wherein the region information may also contain validity periods, such as time or date; in the event of a lack of a match: changing the ZEZ zones in the first map data; providing the first, possibly corrected map data and enriched map data, in particular enriched with validity information that is present.

It is thus proposed herein to improve the data quality of parts of the region-based display (ZEZ zones of the first map data) using the display based on road sections. The effort required for this is able to be expended in a manner focused on critical zones, the exact position and extent of which and the up-to-dateness of which is particularly important.

By way of example, it may be the case that, in ZEZ zones, vehicles are only allowed to drive electrically. Hybrid vehicles, whose fully electric range is particularly limited, are allowed to drive only fully electrically through these ZEZ, and the accuracy of the extent of the ZEZ zone is critical for estimating the possibility of this fully electric passage. LEZ zones on the other hand have lower requirements in terms of emissions and focus only on the type of vehicle. A less accurate indication of the extent is thus sufficient for LEZ zones when using navigation systems in hybrid vehicles.

An easily and dynamically manageable database contains information about emission zones of all kinds (region-based storage), LEZ, ZEZ. ZEZs may already be identified as “not driveable” in a standard map for vehicle navigation (road-based or link-based).

One advantage is that environment zones are able to be managed in a separate database with little effort. In the event of particular criticality, the data however achieve high reliability and accuracy. Another advantage is that the method contributes to increasing the quality of zone information by linking two types of map data.

A match may be understood herein to mean: a) that the map does not contain any road section that lies completely within the ZEZ zone according to the first map data but that is not contained in the list of the ZEZ zone according to the second map data; and b) that the map does not contain any road section that, although it is contained in the list of the ZEZ zone according to the first map data, lies completely outside the ZEZ zone according to the first map data.

The scope of the invention also encompasses a vehicle, comprising storage and/or the ability to communicate with a backend, comprising a map and map data that have been provided in accordance with an above method, wherein the maps may also be present in the backend.

### BRIEF DESCRIPTION OF THE DRAWING

FIG. 1 shows a sketch of a method according to one exemplary embodiment.

### DETAILED DESCRIPTION OF THE DRAWING

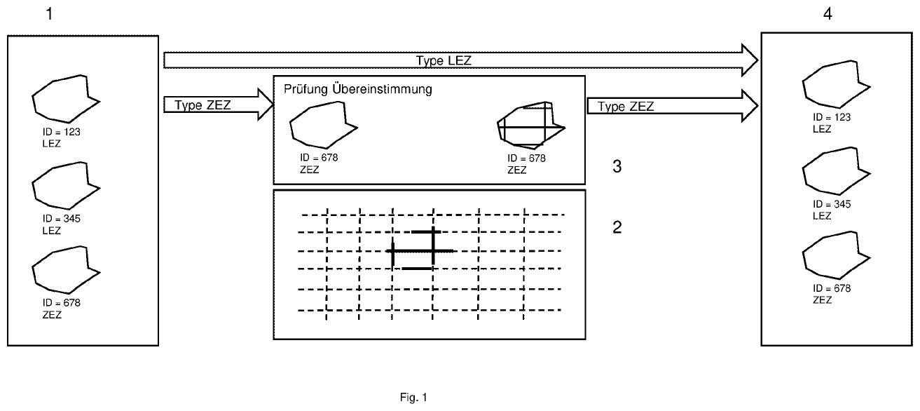

FIG. 1 shows a sketch of a method according to one exemplary embodiment.

The first map data 1 are provided and comprise various zones of the types LEZ and ZEZ in a region display: ID 123 of the type LEZ, ID 345 of the type LEZ and ID 678 of the type ZEZ. At the same time, the map data 2 are provided and comprise a display of the ZEZ in road sections. In step 3, the check for the match for the ZEZ zone ID 678 in accordance with the map database 1 and the map database 2 is performed. In the case of a required correction, the map data 1 is corrected to form the map data 4. These map data 4 are transmitted to the vehicle and used there to find a route, as input for adapting the driving strategy or as an indication to the driver, or are used as a timed indication to the driver, for example only at weekends or after 6 p.m.

1.-3. (canceled)

4. A method for providing map data for at least two types of zones, the method comprising:
providing first map data for a first type of zone and a second type of zone, wherein the zones are described by regions;
providing second map data for the first type of zone, wherein the first type of zone is described by a list of road sections;
providing a map that contains all of the road sections and their positions;
checking, by way of the map, whether the regions mentioned in the first map data for the first type of zone match the road sections mentioned in the second map data for the first type of zone;
upon determining a lack of a match, changing the zones of the first type of zone in the first map data; and
providing the first map data.

5. The method according to claim 4, wherein the match means that:
the map does not contain any road section that lies completely within the first type of zone according to the first map data but that is not contained in the list of the first type of zone according to the second map data; and
the map does not contain any road section that, although the road section is contained in the list of the first type of zone according to the first map data, lies completely outside the first type of zone according to the first map data.

6. A vehicle comprising:
storage,
the map, and
the map data provided by the method according to claim 4.
